(19) United States
(12) Patent Application Publication
(10) Pub. No.: US 2023/0154236 A1
(43) Pub. Date: May 18, 2023

(54) LANDMARK-BASED ENSEMBLE NETWORK CREATION METHOD FOR FACIAL EXPRESSION CLASSIFICATION AND FACIAL EXPRESSION CLASSIFICATION METHOD USING CREATED ENSEMBLE NETWORK

(71) Applicant: INDUSTRY-ACADEMIC COOPERATION FOUNDATION CHOSUN UNIVERSITY, Gwangju (KR)

(72) Inventors: Sung Bum PAN, Gwangju (KR); Young Eun AN, Gwangju (KR); Min Gu KIM, Gwangju (KR)

(21) Appl. No.: 17/979,354

(22) Filed: Nov. 2, 2022

(30) Foreign Application Priority Data
Nov. 18, 2021 (KR) 10-2021-0159493

(51) Int. Cl. G06V 40/16; G06V 10/774; G06V 10/94; G06V 10/82

(52) U.S. Cl. CPC G06V 40/174; G06V 40/171; G06V 10/774; G06V 10/95; G06V 10/82

(57) ABSTRACT

Provided are a landmark-based ensemble network creation method for facial expression classification, and a facial expression classification method using a created ensemble network. More particularly, provided are a landmark-based ensemble network creation method and a facial expression classification method using a created ensemble network, wherein the ensemble network is created through an ensemble method on the basis of facial images and distance information between landmarks for each facial area extracted from the facial images, and facial expression classification is performed using the created ensemble network.

### CROSS REFERENCE TO RELATED APPLICATION

The present application claims priority to Korean Patent Application No. 10-2021-0159493, filed Nov. 18, 2021, the entire contents of which is incorporated herein for all purposes by this reference.

### BACKGROUND OF THE INVENTION

### Field of the Invention

The present disclosure relates to a landmark-based ensemble network creation method for facial expression classification, and a facial expression classification method using a created ensemble network. More particularly, the present disclosure relates to a landmark-based ensemble network creation method and a facial expression classification method using a created ensemble network, wherein the ensemble network is created through an ensemble method on the basis of facial images and distance information between landmarks for each facial area extracted from the facial images, and facial expression classification is performed using the created ensemble network.

### Description of the Related Art

A face recognition technology is one of human body recognition technologies, and can be divided into a face detection technology for finding a face in a captured video, and an authentication technology for determining whether a detected face is a registered user's face.

In the early face authentication technology, a method of distinguishing a detected face with geometrical features of the face was used. However, this was affected by environmental factors, such as facial expressions, illumination, angles, etc., and it was difficult to recognize a face. In order to solve this problem, a complex face authentication technology is being developed, and systems using a face recognition technology as well as iris and fingerprint recognition are being increased.

In addition, recently, research on a facial expression classification technology for determining users' feelings by recognizing the users' facial expressions rather than simply recognizing faces and performing authentication has been conducted. The facial expression classification technology can be used to analyze users' feelings through facial expressions, and can also be widely used in fields such as counseling, recognition psychology, education, human-computer interaction, usability testing, market research, etc. through datafication and analysis of users' feelings.

In general, the facial expression classification technology obtains users' facial images from videos or photos and extracts facial expressions. However, this facial expression recognition technology is also affected by environmental factors, such as illumination, and thus a person's face can be shown in various ways and there are many variables and difficulties in a process of recognizing a face from an obtained video and classifying the facial expression.

Therefore, in order to solve the above-described problems, required are research and development to classify facial expressions accurately by extracting features firm with factors, such as backgrounds, illumination, or angles.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent Document 1) Korean Patent Application Publication No. 10-2019-0081243; and
(Patent Document 4) Korean Patent No. 10-2188970.

### SUMMARY OF THE INVENTION

The present disclosure is directed to providing a landmark-based ensemble network creation method for facial expression classification and a facial expression classification method using a created ensemble network, wherein facial expressions are classified accurately by extracting feature information firm with factors, such as backgrounds, illumination, or angles, from facial images.

According to the present disclosure, there is provided a landmark-based ensemble network creation method including: collecting facial images for each facial expression; extracting landmarks of each facial area from the collected facial images for each facial expression; extracting distance information between the extracted landmarks corresponding to each facial area; creating a plurality of learning models on the basis of the facial images for each facial expression and the distance information for each facial area extracted from each of the facial images; and establishing an ensemble network including a final predictor configured to perform facial expression classification by using outputs of the created plurality of learning models.

In an exemplary embodiment, the facial areas may include an eye area, a nose area, and a mouth area, and in the creating of the plurality of learning models, the following may be created: a first learning model trained with the facial images for each facial expression; a second learning model trained with the distance information of the eye area for each facial expression; a third learning model trained with the distance information of the nose area for each facial expression; and a fourth learning model trained with the distance information of the mouth area for each facial expression.

In an exemplary embodiment, each of the learning models may be trained by a convolution neural network (CNN) algorithm.

In an exemplary embodiment, in the establishing of the ensemble network, a first ensemble network and a second ensemble network may be established, wherein the first ensemble network may include a first final predictor configured to perform facial expression classification by using the outputs of the second learning model, the third learning model, and the fourth learning model, and the second ensemble network may include a second final predictor configured to perform facial expression classification by using the output of the first learning model and an output of the first ensemble network.

In an exemplary embodiment, there is provided a computer program stored in a recording medium to execute the landmark-based ensemble network creation method.

In addition, according to the present disclosure, there is provided a facial expression classification method using a landmark-based ensemble network, the method including: receiving a facial image of which facial expression is to be classified; extracting landmarks of each facial area from the received facial image; calculating distance information between the extracted landmarks corresponding to each facial area; and classifying the facial expression by inputting the received facial image and the distance information corresponding to each facial area to the ensemble network created by the landmark-based ensemble network creation method.

In addition, according to the present disclosure, there is provided a computer program stored in a recording medium to execute the facial expression classification method using the landmark-based ensemble network.

The present disclosure has the following effects.

According to the landmark-based ensemble network creation method for facial expression classification and the facial expression classification method using the created ensemble network according to the present disclosure, the ensemble network is established by creating the plurality of learning models on the basis of the facial images and the distance information derived from the landmarks for each facial area, and final facial expression classification is performed by gathering the prediction results of the plurality of learning models without biasing the prediction result of any one learning model, so that facial expression classification with high accuracy can be performed.

In addition, according to the landmark-based ensemble network creation method for facial expression classification and the facial expression classification method using the created ensemble network according to the present disclosure, since the facial image for facial expression as well as the distance information including the features of muscle movement for each facial area are used together, a facial expression recognition rate is high when facial expression recognition is performed even in various environments, such as backgrounds, illumination, or angles.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart illustrating a landmark-based ensemble network creation method according to an embodiment of the present disclosure;

FIG. 2 is a flowchart illustrating a facial expression classification method using an ensemble network according to an embodiment of the present disclosure; and

FIG. 3 is a diagram illustrating an ensemble network according to an embodiment of the present disclosure.

### DETAILED DESCRIPTION OF THE INVENTION

As the terms used in the present disclosure, general terms that are widely used at present are selected, but terms that are arbitrarily selected by the applicant are used in particular cases. In this case, these terms should be interpreted as not the titles of the terms but the meaning described in the detailed description for implementing the disclosure or the meaning of the terms.

Hereinafter, a technical configuration of the present disclosure will be described in detail with reference to preferred embodiments illustrated in the accompanying drawings.

However, it is to be understood that the present disclosure is not limited to the embodiment described herein, and may be embodied in other forms. Throughout the whole specification, the same reference numerals designate the same elements.

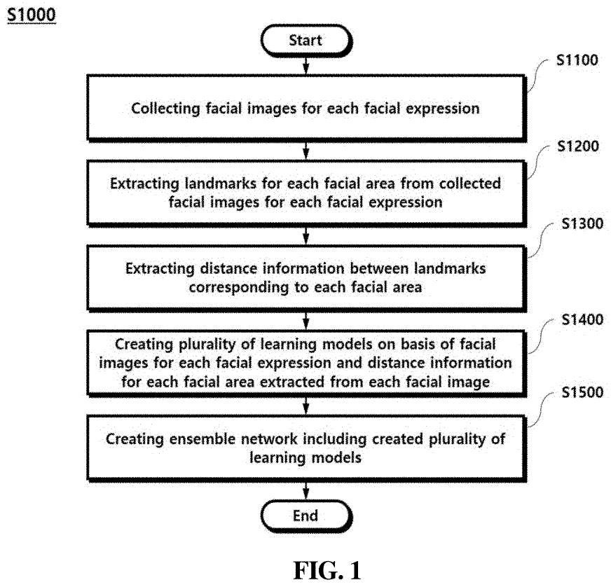

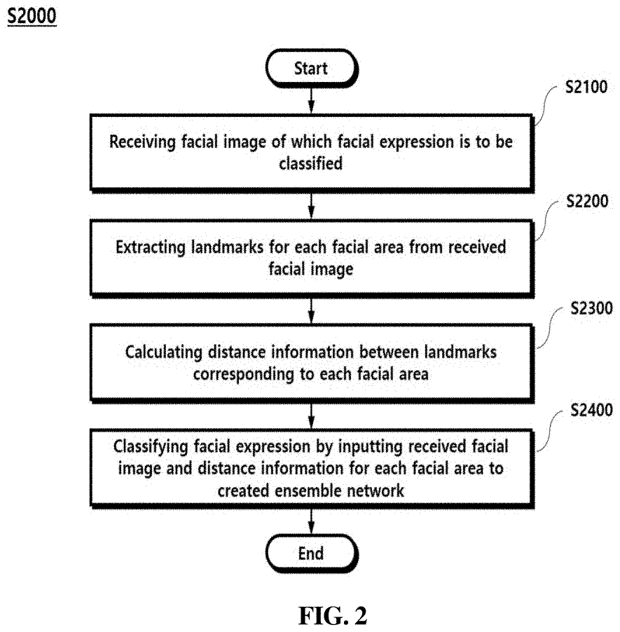

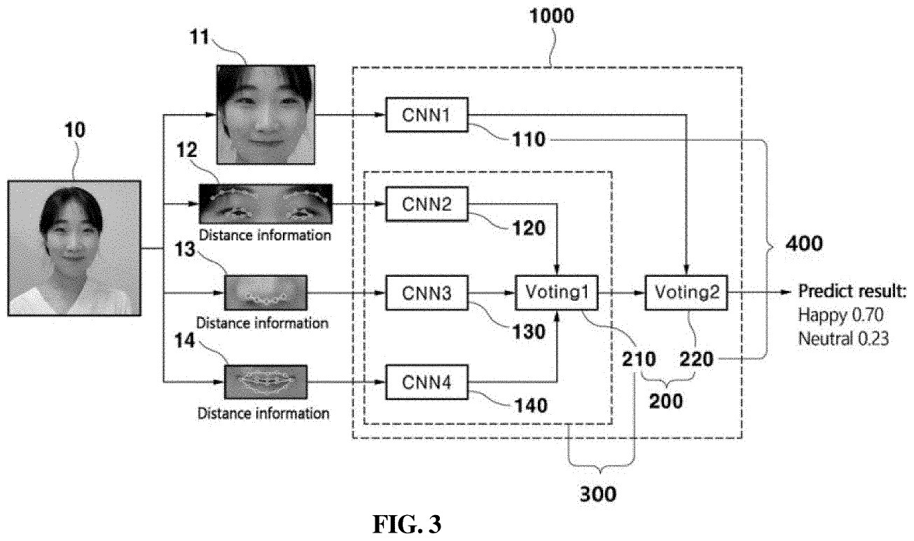

FIG. 1 is a flowchart illustrating a landmark-based ensemble network creation method according to an embodiment of the present disclosure. FIG. 2 is a flowchart illustrating a facial expression classification method using an ensemble network according to an embodiment of the present disclosure. FIG. 3 is a diagram illustrating an ensemble network according to an embodiment of the present disclosure.

Referring to FIGS. 1 to 3, a landmark-based ensemble network creation method S1000 for facial expression classification according to the present disclosure is to establish an ensemble network through an ensemble learning method on the basis of facial images collected for each facial expression and distance information between landmarks of facial areas extracted from each of the facial images.

In addition, a facial expression classification method S2000 using an ensemble network according to the present disclosure relates to a method of performing facial expression classification by inputting, to the ensemble network established using the landmark-based ensemble network creation method S1000, a facial image to be recognized and distance information between landmarks of facial areas extracted from each facial image.

Furthermore, in an embodiment of the present disclosure, the landmark-based ensemble network creation method S1000 and the facial expression classification method S2000 using the ensemble network are executed by a computer. In the computer, a computer program is stored to make the computer function to execute the landmark-based learning model creation method and the facial expression classification method.

In the meantime, the landmark-based learning model creation method S1000 and the facial expression classification method S2000 may also be provided as respective computer programs so as to be executed by the computer.

Furthermore, the computer is a computer in a broad sense including a general personal computer as well as a server computer accessible over a communication network, a cloud system, a smartphone, a smart device such as a tablet computer, and an embedded system.

Furthermore, the computer program may be provided being stored in a recording medium, and the recording medium may be specially designed and configured for the present disclosure, or may be known to those skilled in the field of computer software and usable by them.

For example, the recording medium may be a hardware device that is specially configured to store and perform program commands by a single one or a combination of the following: magnetic recording media, such as hard disks, floppy disks and magnetic tapes, optical recording media, such as CDs and DVDs, magneto-optical recording media for both magnetic and optical recording, ROM, RAM, flash memory, etc.

In addition, the computer program may be a program composed of program commands, local data files, or local data structures, or a combination thereof. Alternatively, the computer program may be a program written in a mechanical language code formatted by a compiler as well as in a high level language code that may be implemented by a computer using an interpreter.

Hereinafter, a landmark-based ensemble network creation method and a facial expression classification method using an ensemble network according to an embodiment of the present disclosure will be described in detail.

First, in the landmark-based ensemble network creation method S1000 according to an embodiment of the present disclosure, facial images for learning are collected for each facial expression in step S1100.

Herein, the collected facial images are images including facial expressions of feeling states including happiness, serenity, sadness, joy, fear, etc.

Next, landmarks are detected from the collected facial images in step S1200.

The detecting of the landmarks means that facial areas, such as the eyes, nose, mouth, chin, etc., existing on a face are detected and the shape of each detected area is represented in feature points, and this may be performed by various known landmark detection algorithms.

For example, as the landmark detection algorithms, a point distribution model algorithm capable of expressing the detected shape with a plurality of points is used, and an active shape model (ASM), an active appearance model (AAM), an explicit shape model (ESM), a supervised descent model (SDM), etc. may be used, and 2D coordinates of landmarks of each facial area may be obtained through the algorithms.

Next, feature vectors for learning are calculated using the extracted landmarks corresponding to each facial area in step S1300.

Specifically, the feature vectors are calculated using the 2D coordinates of the landmarks for each facial area extracted through the landmark detection algorithms. In the present disclosure, landmarks of an eye area including the eyebrows and the eyes, a nose area, and a mouth area, in which large muscle movement changes significantly according to facial expression, are used.

In addition, as the feature vectors, distance information between the landmarks for each facial area is used, and the distance information means a distance value between two or more landmarks corresponding to each facial area.

Furthermore, the distance value may be obtained by known various algorithms capable of calculating a distance by using 2D coordinates. For example, a Euclidean distance algorithm, a Manhattan distance algorithm, a Hamming distance algorithm, etc. for obtaining a distance between two points in 2D coordinates may be used.

In addition, according to the present disclosure, in addition to a distance value between the landmarks corresponding to each facial area, slope information and angle information may be calculated and used as the feature vectors.

Herein, the slope information means a slope value between two landmarks included in the corresponding facial area, and the angle information means an interior angle or exterior angle of a figure shape that may be formed by connecting three or more landmarks included in the corresponding facial area with line segments.

Next, a plurality of learning models are created in step S1400 on the basis of the facial images for each facial expression and the feature vectors extracted from each of the facial images.

Specifically, the following learning models are created: a first learning model 110 trained with the facial images for each facial expression; a second learning model 120 trained with the feature vectors of the eye area of the facial images for each facial expression; a third learning model 130 trained with the feature vectors of the nose area of the facial images for each facial expression; and a fourth learning model 140 trained with the feature vectors of the mouth area of the facial images for each facial expression.

In addition, when the slope information and the angle information of the eye area, the nose area, and the mouth area of the facial images for each facial expression are extracted as the feature vectors, additional learning models trained with the slope information and the angle information corresponding to each area may be created.

In addition, the created learning models may be created by learning data by various artificial neural networks, and may be created by a convolution neural network (CNN) preferably.

In addition, the learning models may be created through the same type of artificial neural networks or different types of artificial neural networks.

Next, an ensemble network is created using the plurality of learning models in step S1500.

The ensemble network is a network established by an ensemble method, and includes the multiple learning models and a final predictor for performing classification/prediction on the basis of output values or result values output from the learning models.

In the present disclosure, the ensemble network 1000 is established including the created first learning model 110, second learning model 120, third learning model 130, and fourth learning model 140, and the final predictor 200 capable of performing facial expression classification based on output values of the respective learning models 110, 120, 130, and 140.

Herein, the first learning model 110, the second learning model 120, the third learning model 130, and the fourth learning model 140 output probabilities of predicted facial expressions when a facial image to be subjected to facial expression classification and feature vectors are input, and the final predictor 200 receives the output probabilities to output a finally predicted facial expression result.

Specifically, the ensemble network 1000 of the present disclosure includes: a first ensemble network 300 including the second learning model 120, the third learning model 130, the fourth learning model 140, and a first final predictor 210 for outputting a first result of facial expression classification by receiving the outputs of the second learning model 120, the third learning model 130, and the fourth learning model 140; and a second ensemble network 400 including the first learning model 110, a second final predictor 220 for outputting a final result of facial expression classification by receiving the output of the first learning model 110 and the output of the first ensemble network 300.

That is, a result of facial expression classification of a facial image to be subjected to facial expression classification is finally output through the second final predictor 220. Each of the final predictors 210 and 220 may be a predictor using a soft voting method in which probability averages of the output values of the learning models are obtained and then a value with the highest probability is selected as a final result.

In addition, the ensemble network 1000 of the present disclosure may be established in a structure in which outputs of the first learning model 110, the second learning model 120, the third learning model 130, and the fourth learning model 140 are connected to one final predictor.

In this way, a facial image to be subjected to facial expression classification and feature vectors are input to the created ensemble network 1000 to perform facial expression classification. Hereinafter, the facial expression classification method S2000 will be described in detail.

First, in the facial expression classification method using the ensemble network of the present disclosure, a facial image 11 to be subjected to facial expression classification is received in real time in step S2100.

Herein, the facial image 11 is a facial image extracted from a video 10 of a person captured in real time, and a process for detecting only the face part from the video 10 may be performed.

In order to detect only the face part from the video 10, various known face detection algorithms may be used. Preferably, a cascade algorithm based on a Haar-like filter may be used.

Next, landmarks of each of the facial areas 12, 13, and 14 are extracted from the received facial image 11 in step S2200, and distance information between the extracted landmarks corresponding to each facial area is calculated to extract feature vectors in step S2300.

Herein, it has been described that the feature vectors are limited to the distance information. However, it is preferable that when the learning models are created further using slope information and angle information as the feature vectors in the ensemble network creation method S1000, slope information and angle information are further extracted similarly.

Next, the received facial image 11 and the feature vectors of each of the facial areas 12, 13, and 14 extracted from the received facial image 11 are input to each of the learning models 110, 120, 130, and 140 of the ensemble network 1000 created by the ensemble network creation method S1000, and facial expression classification is performed.

According to the landmark-based ensemble network creation method for facial expression classification and the facial expression classification method using the created ensemble network according to the present disclosure, the ensemble network is established by creating the plurality of learning models on the basis of the facial images and the distance information derived from the landmarks for each facial area, and final facial expression classification is performed by gathering the prediction results of the plurality of learning models without biasing the prediction result of any one learning model, so that facial expression classification with high accuracy can be performed.

In addition, according to the landmark-based ensemble network creation method for facial expression classification according to the present disclosure, since the facial image and the distance information including the features of muscle movement for each facial area are used together, a facial expression recognition rate is high when facial expression classification is performed even in various environments, such as backgrounds, illumination, or angles.

As described above, while the present disclosure has been illustrated and described in conjunction with the preferred embodiment, the present disclosure is not limited to the aforementioned embodiment. The embodiment can be changed and modified in various forms by those skilled in the art without departing from the spirit of the disclosure.

What is claimed is:

1. A landmark-based ensemble network creation method, comprising:
collecting facial images for each facial expression;
extracting landmarks of each facial area from the collected facial images for each facial expression;
extracting distance information between the extracted landmarks corresponding to each facial area;
creating a plurality of learning models on the basis of the facial images for each facial expression and the distance information for each facial area extracted from each of the facial images; and
establishing an ensemble network including a final predictor configured to perform facial expression classification by using outputs of the created plurality of learning models.

2. The method of claim 1, wherein the facial areas are classified into an eye area, a nose area, and a mouth area, and
in the creating of the plurality of learning models, the following are created:
a first learning model trained with the facial images for each facial expression;
a second learning model trained with the distance information of the eye area for each facial expression;
a third learning model trained with the distance information of the nose area for each facial expression; and
a fourth learning model trained with the distance information of the mouth area for each facial expression.

3. The method of claim 2, wherein each of the learning models is trained by a convolution neural network (CNN) algorithm.

4. The method of claim 3, wherein in the establishing of the ensemble network, a first ensemble network and a second ensemble network are established, wherein the first ensemble network includes a first final predictor configured to perform facial expression classification by using the outputs of the second learning model, the third learning model, and the fourth learning model, and the second ensemble network includes a second final predictor configured to perform facial expression classification by using the output of the first learning model and an output of the first ensemble network.

5. A computer program stored in a recording medium to execute the landmark-based ensemble network creation method according to claim 4.

6. A facial expression classification method using a landmark-based ensemble network, the method comprising:
receiving a facial image of which facial expression is to be classified;
extracting landmarks of each facial area from the received facial image;
calculating distance information between the extracted landmarks corresponding to each facial area; and
classifying the facial expression by inputting the received facial image and the distance information corresponding to each facial area to the ensemble network created by the method according to claim 4.

7. A computer program stored in a recording medium to execute the facial expression classification method using the landmark-based ensemble network according to claim 6.
